(19) United States
(12) Patent Application Publication
(10) Pub. No.: US 2024/0371548 A1
(43) Pub. Date: Nov. 7, 2024

(54) DEADFRONT ARRESTER WITH SECURED MOV STACK

(71) Applicant: Hubbell Incorporated, Shelton, CT (US)

(72) Inventors: David Charles Hughes, Aiken, SC (US); Bastiaan Hubertus Van Besouw, Strongsville, OH (US)

(21) Appl. No.: 18/652,127

(22) Filed: May 1, 2024

Related U.S. Application Data
(60) Provisional application No. 63/463,348, filed on May 2, 2023.

(51) Int. Cl. H01C 1/022; H01C 1/08; H01C 7/12

(52) U.S. Cl. CPC H01C 1/022; H01C 1/08; H01C 7/12

(57) ABSTRACT

Surge arresters having secured MOV stacks. One surge arrester device includes a first housing portion including a first end and a second end, the first end including a first opening and the second end including a second opening, and a second housing portion protruding from an intermediate section of the first housing portion. The surge arrester device includes an MOV stack secured within the second housing portion by a MOV stack housing. The MOV stack is maintained within the second housing portion during a fault to ground condition of the surge arrester.

### CROSS REFERENCE TO RELATED APPLICATIONS

This application claims the benefit of U.S. Provisional Patent Application No. 63/463,348, filed May 2, 2023, the entire contents of which are hereby incorporated by reference.

### FIELD

The present disclosure relates to overvoltage protection assemblies, and more specifically, to surge arresters having metal oxide varistor (MOV) stacks.

### SUMMARY

Surge arresters are commonly used to protect underground high voltage electrical systems from power surges. Surge arresters include metal oxide varistor (MOV) elements to provide a low or high impedance path depending on the voltage of the power system. During normal operation, the MOV element has a high impedance, resulting in little current flowing through the surge arrester. However, if a power surge occurs, such as a surge resulting from a lightning strike, the impedance of the MOV element decreases. Surge current flows through the arrester to protect other components of the power system. However, the surge arrester may fail, creating an undesirable low impedance fault. If the surge arrester fails, then power frequency fault current flows through the arrester to ground. In this case the failed surge arrester is said to have faulted to ground. Surge arrester failures faulting to ground may be dangerous occurrences, as the fault current generates hot gasses, plasma, and electrical arcs, which are expelled from the device.

To mitigate some damage experienced as a result of the surge arrester failure, embodiments described herein prevent the MOV elements from exiting the housing of the surge arrester during failure. While hot gasses, plasma, and flames may exit the housing, the MOV stack itself is secured and constrained within the housing, preventing the shrapnel danger of fragmented MOV blocks.

In one embodiment, a surge arrester device includes a first housing portion including a first end and a second end, the first end including a first opening and the second end including a second opening. The surge arrester device includes a second housing portion protruding from an intermediate section of the first housing portion and a metal oxide varistor (MOV) stack secured within the second housing portion by a MOV stack housing. The MOV stack is maintained within the second housing portion during a fault to ground condition of the surge arrester device.

In some embodiments, the surge arrester device includes a first axis parallel to the first housing portion, the first axis intersecting a first center of the first opening and a second center of the second opening, and a second axis perpendicular to the first housing portion, the second axis intersecting the intermediate section of the first housing portion. The second housing portion protrudes from the intermediate section of the first housing portion at an angle between the first axis and the second axis. In some embodiments, the first housing portion includes a plug interface configured to receive an insulating plug via the first opening and a bushing interface configured to receive a bushing via the second opening. In some embodiments, the MOV stack housing includes a plurality of vents configured to release gas created by the MVO stack. In some embodiments, the MOV stack housing is composed of fiberglass.

In some embodiments, the surge arrester device includes a metallic connector spade situated at the intermediate section of the first housing portion, the metallic connector spade configured to connect an insulating plug and a bushing. The MOV stack housing is coupled to the metallic connector spade via a fastener. In some embodiments, the first housing portion and the second housing portion include an elastomeric primary insulation, and a portion of the metallic connector spade is chemically bonded to the elastomeric primary insulation via a conductive elastomeric insert. In some embodiments, a portion of the MOV stack housing is chemically bonded to the elastomeric primary insulation. In some embodiments, the surge arrester device includes a ground connection coupled to a lower portion of the MOV stack housing via a fastener. In some embodiments, the surge arrester device includes a sealing surface situated adjacent to the ground connection and a bottom plate situated at an opening of the second housing portion. The sealing surface and the bottom plate form a seal at the opening of the second housing portion. In some embodiments, during the fault to ground condition of the surge arrester device, a pathway is provided between the sealing surface and an elastomeric primary insulation of the second housing portion.

Another embodiment provides another surge arrester device. The surge arrester device includes a first housing portion including a first end and a second end, the first end including a first opening and the second end including a second opening. The surge arrester device includes a second housing portion protruding from an intermediate section of the first housing portion and a metallic connector spade situated at the intermediate section of the first housing portion, the metallic connector spade configured to connect an insulating plug received at the first opening and a bushing received at the second opening. The surge arrester device includes a MOV stack housing containing an MOV stack, the MOV stack housing coupled to the metallic connector spade. During a fault to ground condition of the surge arrester device, a pathway is formed between the MOV stack housing and the second housing portion.

In some embodiments, the surge arrester device includes a first axis parallel to the first housing portion, the first axis intersecting a first center of the first opening and a second center of the second opening, and a second axis perpendicular to the first housing portion, the second axis intersecting the intermediate section of the first housing portion. The second housing portion protrudes from the intermediate section of the first housing portion at an angle between the first axis and the second axis. In some embodiments, the MOV stack housing includes a plurality of vents configured to release gas created by the MOV stack. In some embodiments, the MOV stack housing is composed of fiberglass.

In some embodiments, the first housing portion and the second housing portion include an elastomeric primary insulation, and a portion of the metallic connector spade is chemically bonded to the elastomeric primary insulation. In some embodiments, a portion of the MOV stack housing is chemically bonded to the elastomeric primary insulation via a conductive elastomeric insert. In some embodiments, the surge arrester device further includes a ground connection coupled to a lower portion of the MOV stack housing via a fastener. In some embodiments, the surge arrester device includes a sealing surface situated adjacent to the ground connection and a bottom plate situated at an opening of the second housing portion. The sealing surface and the bottom plate form a seal at the opening of the second housing portion In some embodiments, during the fault to ground condition of the surge arrester device, the seal formed at the opening of the second housing portion is opened to provide the pathway between the MOV stack housing and the second housing portion.

Other aspects of the application will become apparent by consideration of the detailed description and accompanying drawings.

### BRIEF DESCRIPTION OF THE DRAWINGS

FIG. 1A illustrates a perspective view of a surge arrester, according to some embodiments.

FIG. 1B illustrates a cross-sectional view of the surge arrester of FIG. 1A, according to some embodiments.

FIG. 2 illustrates a cross-sectional view of an upper housing portion of the surge arrester of FIGS. 1A-1B, according to some embodiments.

FIG. 3 illustrates a cross-sectional view of a lower housing portion of the surge arrester of FIGS. 1A-1B, according to some embodiments.

FIG. 4 illustrates a cross-sectional view of a seal in the surge arrester of FIGS. 1A-1B, according to some embodiments.

### DETAILED DESCRIPTION

Before any embodiments of the application are explained in detail, it is to be understood that the application, and the devices and method described herein, are not limited in their application to the details of construction and the arrangement of components set forth in the following description or illustrated in the following drawings. The devices and methods in this application are capable of other embodiments and of being practiced or of being carried out in various ways.

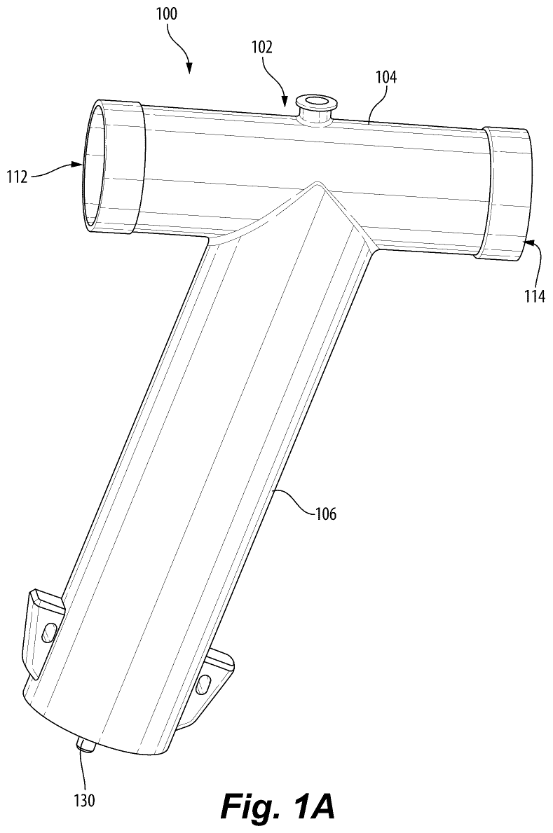

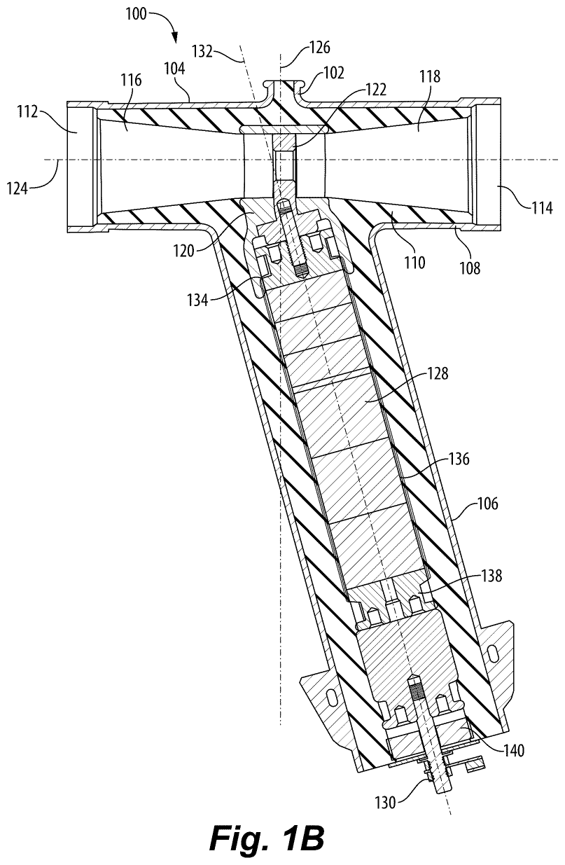

FIGS. 1A-1B illustrate a surge arrester 100 (e.g., a tee arrester, a deadfront arrester, a lightning arrester, a bushing arrester, a 200A loadbreak arrester, a 600A deadbreak arrester, or the like) according to some embodiments. The surge arrester 100 includes a housing 102 that includes a first housing portion 104 and a second housing portion 106. The housing 102 may be composed of an insulating material to protect external equipment and workers from high voltages that may be present within the surge arrester 100. For example, the housing 102 includes an elastomeric conductive shell 108 and an elastomeric primary insulation 110. The elastomeric conductive shell 108 may be composed of, for example, a conducting EPDM. The elastomeric primary insulation 110 may be composed of, for example, an insulating EPDM. In some embodiments, all components other than electrical connection points may be insulated such that they are electrically shielded.

The first housing portion 104 includes a first opening 112 at a first end of the first housing portion 104 and a second opening 114 at a second end of the first housing portion 104. The first housing portion 104 includes a plug interface 116 configured to receive an insulating plug, reducing tap plug, reducing tap well, or connecting plug via the first opening 112. In some embodiments, the insulating plug, reducing tap plug, reducing tap well, or connecting plug is integrated within the first housing portion 104, such that there is no opening 112 or interface 116 and the plug and housing are molded as one unit. In some instances, the first housing portion 104 includes only a single opening. The first housing portion 104 includes a bushing interface 118 configured to receive a bushing via the second opening 114. The bushing may be, for example, a 600 A standard shaped bushing. The bushing may be configured to couple the surge arrester 100 with an underground power system, such as a 15 kV, 25 kV, 28 kV, or 35 kV underground system. The first housing portion 104 also includes an elastomeric conductive insert 120 and a metallic connector spade 122. The metallic connector spade 122 couples the plug interface 116 to the bushing interface 118. Additionally, should an insulating plug be located within the plug interface 116, the insulating plug may couple to a bushing within the bushing interface 118 via the metallic connector spade 122.

The first housing portion 104 includes a longitudinal (e.g., first) axis 124 parallel to the first housing portion 104. The longitudinal axis 124 passes through the first housing portion 104, intersecting the first housing portion 104 at a center of the first opening 112 and at a center of the second opening 114. The first housing portion 104 further includes a latitudinal (e.g., second) axis 126 perpendicular to the longitudinal axis 124. The latitudinal axis 126 intersects the first housing portion 104 at an intermediate section of the first housing portion 104.

The second housing portion 106 protrudes from the intermediate section of the first housing portion 104 and includes a metal oxide varistor (MOV) stack 128 and a ground connection assembly 130 coupled to a system ground (not shown). The ground connection assembly 130 may further include a cap configured to disconnect the ground connection assembly 130 from the second housing portion 106 upon a failure of the surge arrester 100. In some embodiments, the cap includes a hole configured to allow hot gas to escape the housing 102.

The second housing portion 106 protrudes from the first housing portion 104 along a third axis 132. The third axis 132 is situated at an angle between the longitudinal axis 124 and the latitudinal axis 126. For example, the second housing portion 106 may protrude from the first housing portion 104 along the third axis 132 at a 20° angle from the latitudinal axis 126. The first housing portion 104 and the second housing portion 106, in combination, form a general “T” shape.

The MOV stack 128 is coupled to the ground connection assembly 130 to provide an electrical connection between the system ground and the metallic connector spade 122. In some embodiments, the MOV stack 128 is composed of several MOV disks joined into a single assembly. The MOV stack 128 has a resistance that changes based on the voltage of the surge arrester 100. At a normal operating voltage, the MOV stack 128 has a high resistance and restricts current from flowing through the surge arrester 100. In the case of a power surge (e.g., a lightning strike, a voltage increase, etc.), the resistance of the MOV stack 128 decreases and allows current to flow through the surge arrester 100 to the system ground. For example, when the current becomes greater than a current threshold (i.e., maximum current of the MOV stack 128), the surge arrester 100 begins to fail (i.e., a fault to ground condition).

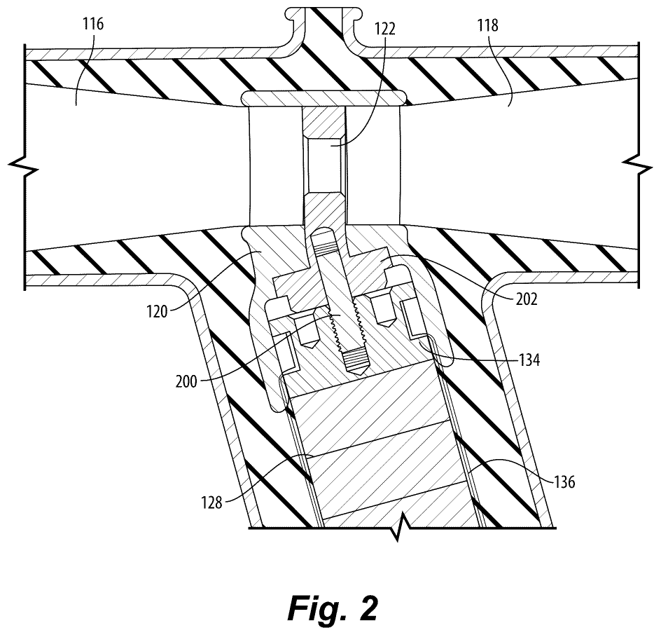

The MOV stack 128 is surrounded by (e.g., contained within) an MOV housing 136 configured to maintain the MOV stack 128 within the second housing portion 106. The MOV housing 136 may be composed of, for example, fiberglass. In some implementations, the MOV housing 136 includes a plurality of vents to allow gas released by the MOV stack 128 to escape. To secure the MOV stack 128 within the housing 102, an upper connecting portion 134 of the MOV housing 136 is secured to a bottom portion of the metallic connector spade 122. For example, as shown in FIG. 2, a fastener 200 (e.g., a stud, a bolt, etc.) couples the upper connecting portion 134 of the MOV housing 136 to a first plate 202. The first plate 202 may be, for example, a bottom portion of the metallic connector spade 122. The first plate 202 may be composed of a metal, such as aluminum.

In some implementations, the first plate 202 is bonded to the elastomeric conductive insert 120. For example, the first plate 202 may be chemically bonded to the elastomeric conductive insert 120 using an adhesive. The elastomeric conductive insert 120 may itself be bonded with the elastomeric primary insulation 110. Accordingly, in the case of a failure, the MOV stack 128 is maintained within the MOV housing 136 and secured by the fastener 200. The elastomeric conductive insert 120 forms a seal between the metallic connector spade 122 and the MOV stack 128 such that no pressure escapes the MOV stack to the bushing and insulative plug.

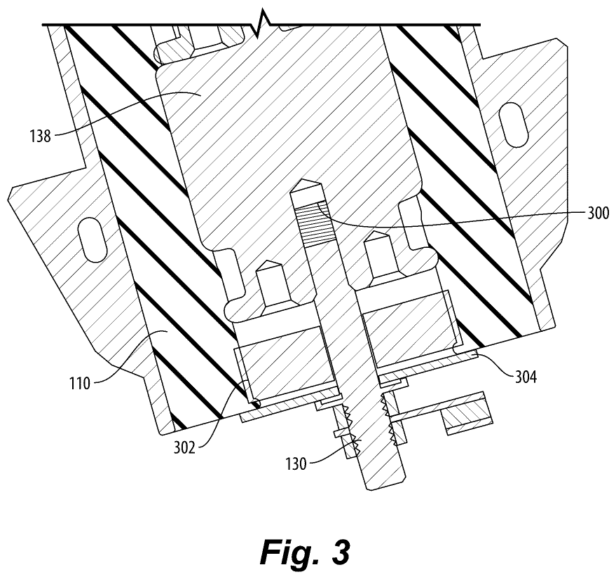

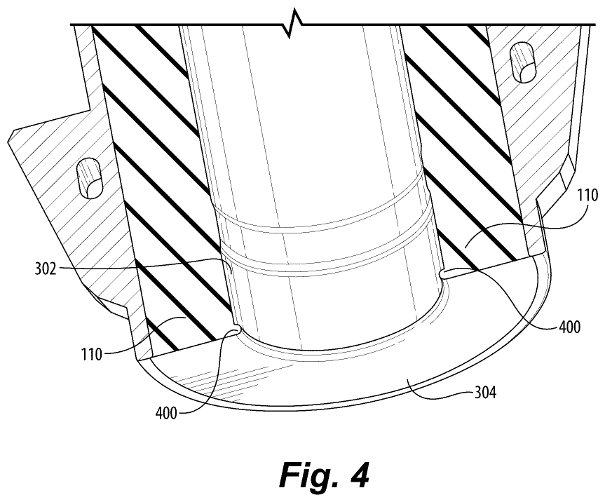

Referring now to FIG. 3, a bottom portion of the surge arrester 100 includes a lower connecting portion 138 extending from the MOV housing 136, a second fastener 300, a sealing surface 302, and a bottom plate 304 (e.g., a bottom cap). The second fastener 300 secures the ground connection assembly 130 to the lower connecting portion 138. The sealing surface 302 seals the MOV stack 128 from the external environment, preventing water and other contaminants from entering the surge arrester 100. The bottom plate 304 is provided as additional protection and for applying pressure to the sealing surface 302 to create the seal. For example, as shown in FIG. 4, a gasket 400 is provided between the sealing surface 302 and the bottom plate 304. The elastomeric primary insulation 110 is pinched within the gasket 400 and between the sealing surface 302 and the bottom plate 304 to create the seal.

When the surge arrester 100 fails, the MOV stack 128 releases heat and, as the power surge continues for a period of time, the MOV stack 128 may continue to release dangerous hot gas through vents in the MOV housing 136 and build up pressure within the housing 102. In some embodiments, when the dangerous hot gas builds enough internal pressure, the pressure and expansion of the MOV stack 128 pushes the elastomeric primary insulation 110 (and, in some instances, the elastomeric conductive shell 108) outwards and away from the MOV stack 128. This expansion pushes the elastomeric primary insulation 110 out of the gasket 400, breaking the seal between the sealing surface 302 and bottom plate 304 and providing a pathway out of the housing 102 for the hot gas and heat released by the MOV stack 128.

Thus, the application provides, among other things, a surge arrester having an MOV stack. Various features and advantages of the application are set forth in the following claims.

What is claimed is:

1. A surge arrester device comprising:
a first housing portion including a first end and a second end, the first end including a first opening and the second end including a second opening;
a second housing portion protruding from an intermediate section of the first housing portion; and
a metal oxide varistor (MOV) stack secured within the second housing portion by a MOV stack housing,
wherein the MOV stack is maintained within the second housing portion during a fault to ground condition of the surge arrester device.

2. The surge arrester device of claim 1, further comprising:
a first axis parallel to the first housing portion, the first axis intersecting a first center of the first opening and a second center of the second opening; and
a second axis perpendicular to the first housing portion, the second axis intersecting the intermediate section of the first housing portion,
wherein the second housing portion protrudes from the intermediate section of the first housing portion at an angle between the first axis and the second axis.

3. The surge arrester device of claim 1, wherein the first housing portion further includes:
a plug interface configured to receive an insulating plug via the first opening; and
a bushing interface configured to receive a bushing via the second opening.

4. The surge arrester device of claim 1, wherein the MOV stack housing includes a plurality of vents configured to release gas created by the MOV stack.

5. The surge arrester device of claim 1, wherein the MOV stack housing is composed of fiberglass.

6. The surge arrester device of claim 1, further comprising:
a metallic connector spade situated at the intermediate section of the first housing portion, the metallic connector spade configured to connect an insulating plug and a bushing,
wherein the MOV stack housing is coupled to the metallic connector spade via a fastener.

7. The surge arrester device of claim 6, wherein the first housing portion and the second housing portion include an elastomeric primary insulation, and wherein a portion of the metallic connector spade is chemically bonded to the elastomeric primary insulation.

8. The surge arrester device of claim 1, wherein the first housing portion and the second housing portion include an elastomeric primary insulation, and wherein a portion of the MOV stack housing is chemically bonded to the elastomeric primary insulation.

9. The surge arrester device of claim 1, further comprising:
a ground connection coupled to a lower portion of the MOV stack housing via a fastener.

10. The surge arrester device of claim 9, further comprising:
a sealing surface situated adjacent to the ground connection; and
a bottom cap situated at an opening of the second housing portion,
wherein the sealing surface and the bottom cap form a seal at the opening of the second housing portion.

11. The surge arrester device of claim 10, wherein, during the fault to ground condition of the surge arrester device, a pathway is provided between the sealing surface and an elastomeric primary insulation of the second housing portion.

12. A surge arrester device comprising:
a first housing portion including a first end and a second end, the first end including a first opening and the second end including a second opening;
a second housing portion protruding from an intermediate section of the first housing portion;
a metallic connector spade situated at the intermediate section of the first housing portion, the metallic connector spade configured to connect an insulating plug received at the first opening and a bushing received at the second opening; and
a metal oxide varistor (MOV) stack housing containing an MOV stack, the MOV stack housing coupled to the metallic connector spade;
wherein, during a fault to ground condition of the surge arrester device, a pathway is formed between the MOV stack housing and the second housing portion.

13. The surge arrester device of claim 12, further comprising:
a first axis parallel to the first housing portion, the first axis intersecting a first center of the first opening and a second center of the second opening; and
a second axis perpendicular to the first housing portion, the second axis intersecting the intermediate section of the first housing portion,
wherein the second housing portion protrudes from the intermediate section of the first housing portion at an angle between the first axis and the second axis.

14. The surge arrester device of claim 12, wherein the MOV stack housing includes a plurality of vents configured to release gas created by the MOV stack.

15. The surge arrester device of claim 12, wherein the MOV stack housing is composed of fiberglass.

16. The surge arrester device of claim 12, wherein the first housing portion and the second housing portion include an elastomeric primary insulation, and wherein a portion of the metallic connector spade is chemically bonded to the elastomeric primary insulation.

17. The surge arrester device of claim 12, wherein the first housing portion and the second housing portion include an elastomeric primary insulation, and wherein a portion of the MOV stack housing is chemically bonded to the elastomeric primary insulation.

18. The surge arrester device of claim 12, further comprising:
a ground connection coupled to a lower portion of the MOV stack housing via a fastener.

19. The surge arrester device of claim 18, further comprising:
a sealing surface situated adjacent to the ground connection; and
a bottom cap situated at an opening of the second housing portion,
wherein the sealing surface and the bottom cap form a seal at the opening of the second housing portion.

20. The surge arrester device of claim 19, wherein, during the fault to ground condition of the surge arrester device, the seal formed at the opening of the second housing portion is opened to provide the pathway between the MOV stack housing and the second housing portion.
